(19) United States
(12) Patent Application Publication
(10) Pub. No.: US 2009/0133475 A1
(43) Pub. Date: May 28, 2009

(54) Apparatus for Permeation or Substance Passage Investigations

(76) Inventors: Karin Glock-Jager, Vacha (DE); Katrin Pawlik, Jena (DE); Thomas Richter, Jena (DE)

Correspondence Address: JORDAN AND HAMBURG LLP, 122 EAST 42ND STREET, SUITE 4000, NEW YORK, NY, 10168, US

(21) Appl. No.: 12/085,590

(22) PCT Filed: Nov. 15, 2006
(86) PCT No.: PCT/DE2006/002020

§ 371 Date: Dec. 29, 2008

(30) Foreign Application Priority Data
Nov. 25, 2005 (DE) 10 2005 057 031.3

(51) Int. Cl. G01N 15/08

(52) U.S. Cl. 73/38

(57) ABSTRACT

An apparatus for permeation or substance passage investigations, in particular for investigations on materials, for example polymers, plastic films, packaging, coatings, paper, wood (veneer) or the like, is operable independently of an analyzing device in terms of time and location. The apparatus includes a measuring cell, and a sample space and a measuring space defined by a sample which, when received in the measuring cell, divides the measuring cell into the sample space and the measuring space in such a manner that permeation or substance passage can take place solely through the sample.

The invention relates to an apparatus for permeation or substance passage investigations, particularly for investigations on materials, for example plastic films and packaging, coatings, or the like, which can be operated independently of the analyzing device in terms of time and location.

It is known that the permeation measurement is performed in two stages. In the first stage, the substrate to be tested is subject to the permeating medium in a special sample space or measuring cell. In the second stage, the volume, the mass and/or the composition of the substance that permeated through said substrate are analyzed.

According to the prior art, the two stages of permeation measurement are directly coupled with each other, for example by the direct transfer of the permeated substance from the sample space into the analyzing device by means of a carrier gas flow. Here said substance is immediately measured (e.g. using an electrochemical measuring cell, a gas chromatograph or a mass spectrometer).

The permeation itself proceeds in the following four steps:
1. the substance is adsorbed on the surface of the sample, e.g. of the polymer film,
2. the substance is absorbed on the surface of the sample, e.g. of the polymer film, and thus penetrates into the sample/the polymer,
3. the substances diffuses through the sample/the polymer up to the opposite interface,
4. the substance is desorbed on the opposite surface of the sample, e.g. of the polymer film.

The step that determines the speed of a permeation measurement is mostly the permeation process itself, i.e. the adsorption and absorption of the substance on the polymer surface, the diffusion through the polymer and the desorption of the substance by the opposite polymer surface. The most slowest process of these single steps is the diffusion. The permeation process can take minutes, but also hours or even days, if an artificially produced additional pressure difference between the two sample spaces does not exist (so called “no-pressure” process).

Therefore, the procedures used so far are very time-consuming and have only a limited suitability for a high-throughput analysis.

Up to now, the following methods of permeation measurements are known:
volumetric measurement according to DIN 53380-1 (gas permeation)
manometric measurement according to DIN 53380-2
gravimetric measurement according to DIN 53122-1.

All these measurement procedures have the disadvantage that the two stages of permeation measurement are coupled directly with each other and the measuring cells are not independent of the analyzing device. This fact is particularly disadvantageous for no-pressure procedures because the individual measurement takes long periods of time.

As in the course of the development of polymer films and barrier layers for the packaging and electronic industries, for the field of occupational safety, etc., the demands are continuously going up, the trend is towards increasingly lower permeation rates that lead to increasingly longer permeation times. In addition to this, more and more sensitive measuring methods are required so that the mentioned disadvantage of the permeation measurements used so far will take even more effect in the future.

The specification JP 2003106971 A describes a method for measuring the vapor permeability of a film or of a film containing pores. The permeation process is speeded up by applying pressure onto one side of the film. The quantity to be measured is always the amount of gas per time unit.

The patent U.S. Pat. No. 6,804,989 B2 specifies a method for measuring very low water permeation rates. In this method, tritium-enriched water is used that is enriched after the permeation in a gas flow. For the analysis, the radioactivity is measured.

The patent US 2002/0152800 A1 describes a method in which the substrate is reacted with specific Ca- or Ba-compounds that react with the diffused water. Transmission and reflection measurements are used for the detection.

The U.S. Pat. No. 6,043,027 refers to the measurement of the permeation of chemicals through cells that have specific corrugated sheet structure. These arrangements and similar ones can be used for example in the field of medicine for measuring the permeation of drugs through the intestinal wall.

The patent DE 697 24 504 T2 describes a method for investigating food packaging materials, particularly organic and inorganic gas barrier films.

All the patents just mentioned describe different arrangements and methods to measure the permeation of water or moisture and volatile, liquid substances.

In each method, the sample space where the permeation process takes place is directly coupled with the analysis. Consequently, the methods described are particularly time-consuming for low penetration rates.

Furthermore, the patent EP 0 425 809 A2 shows that the permeation of external molecules into a solid can be determined by measuring the amount of the diffused external molecules.

The disadvantage of this procedure is the fact that only the diffusion of external molecules into a sample can be determined, but not its penetration through the sample.

Therefore, the object of this invention is to specify an apparatus for permeation or substance passage investigations, particularly for investigations on polymers, that avoids the disadvantages of the prior art, in particular can be handled independently of the analysis in terms of time and location.

According to the present invention, this task is solved by the elements of the first patent claim and supported by advantageous embodiments according to the subclaims.

The invention is based on an apparatus that comprises a cell that is divided by the sample to be tested into two spaces, a measuring space and a sample space, and it is possible to fill the permeating medium into the sample space and to take the permeated substance to be analyzed, or a part whereof, out of the measuring space after an appropriate reaction time.

Due to said arrangement of the inventive apparatus the permeation or the substance passage can be performed independently of the second stage of permeation measurement, the analysis of the permeated substance in the analyzing device, in terms of time and location. This was not possible for the devices used for permeation measurement so far.

In the following, an example explains the invention in detail in a schematic drawing.

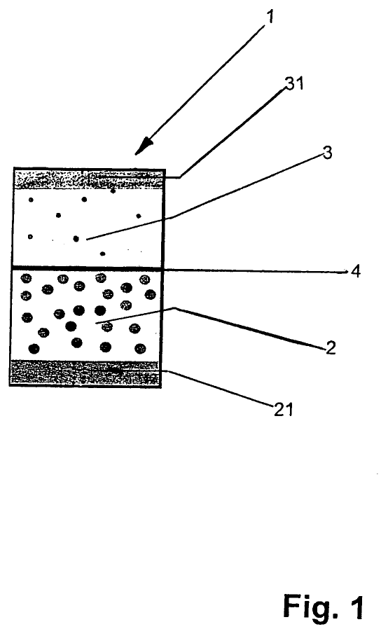

FIG. 1 shows a schematic drawing of the inventive apparatus.

The sample 4, e.g. a polymer film, a coating or a film, which can be filled into a measuring cell 1, divides the measuring cell 1 of the inventive apparatus into two spaces, the sample space 2 and the measuring space 3.

In a particularly advantageous embodiment the sample space 2 is provided with a septum 21.

Via this septum 21 the sample space 2 can be filled with permeating substance(s). Said substance(s) can be solid, liquid and/or volatile or gaseous. It preferably permeates without pressure through the sample 4 into the measuring space 3.

If required, it is also possible to take a sample via the septum 21 in the sample space 2 (depletion principle).

An alternative solution for the septum 21 is the use of a charge system provided with quick acting closures, screwed connections and/or valves through which the permeating substance(s) can be filled into the sample space 2 and which allows the sample taking in the sample space 2 (depletion principle).

According to the invention, the measuring space 3 can be provided with a further septum 31 or alternatively with a discharge system provided with quick acting closures, screwed connections and/or valves. The analysis sample can be taken via the septum 31 or the discharge system and be supplied to any independent analysis method.

The measuring space 3 can be filled for example with an absorption medium or a gaseous analyte.

It is also part of the invention that an appropriate system is used for keeping the temperature of the complete apparatus at a constant level, if required.

Thanks to the fact that the inventive apparatus can be individually arranged it can be used for automatic sampling, the appropriate spatial/geometric design provided.

As the inventive apparatus—unlike commercial measuring cells—is not permanently connected to the analyzing device the selection between different, any suited analyzing methods is possible. This arrangement has the advantage that directly after sampling the apparatus can be replaced by a further inventive apparatus with a new sample.

If the permeated substance being in the measuring space 3 is not completely but only partly taken out via the septum 31 or the discharging system during sampling in the inventive apparatus, the contents of the measuring space 3 can be analyzed anew and possibly by applying further analyzing methods after a certain period of time in which the permeation process progresses.

Here, it is particularly advantageous that the inventive apparatus can be handled independently of the analyzing device in terms of time and location.

It is also possible and part of the invention to take the complete content out of the measuring space for analyzing purposes after a certain time and to replace it by a fresh gaseous analyte or absorption medium. This procedure also allows to analyze the content of the measuring space 3 anew after a certain time in which the permeation progresses, and further analyzing methods can be applied, too.

For this complete sampling it is also particularly advantageous that the inventive apparatus can be operated independently of the analyzing device in terms of time and location.

Another particularly advantageous fact of the inventive apparatus is the possibility of combining different analyzing methods for the first time, because all components of the sample of a measuring cell can be tested.

The possibility to replace the inventive, device-independent arrangement allows to analyze a large sample amount per time unit even in permeation processes that require a longer period and to efficiently use the measuring equipment.

The inventive apparatus can be used for example for testing and characterizing packaging materials, such as food packaging or PET bottles, for testing for example the tightness of safety gloves to chemicals or their minimum permeability to moisture, and for investigating barrier layers, e.g. in the fields of corrosion protection or environmental protection and said apparatus can be handled independently of the analyzing device in terms of time and location.

The advantage of this invention is the specification of an apparatus that can be operated completely independently of the analyzing device and is characterized by the deliberate locally- and time-related separation of the permeation measurement into two stages (permeation and analysis). Thus, the apparatus in which the permeation process takes place must not necessarily remain in the analyzing device during the total time of measurement.

Therefore, it is possible for the first time to start the permeation process almost simultaneously for several samples by using numerous single measuring cells (number of samples corresponds to the number of the measuring cells).

The sampling can also be performed almost simultaneously or in short sequences for all samples. According to the availability of the analyzing device(s), the analyses can be principally carried out for the single samples in different devices then.

During the permeation process itself the relevant analyzing device is not blocked any longer but can be used effectively for other tests.

If the filling of the inventive apparatus and the analyses are organized in a time-shifted manner the time saved will become obvious and it becomes also clear that the sample rate per time unit can be increased by this inventive apparatus. The permeation or substance passage can be tested as follows:
1. gaseous substances/substance mixtures through sample in carrier gas,
2. gaseous substances/substance mixtures through sample in absorption medium,
3. liquid substances/substance mixtures through sample in carrier gas,
4. liquid substances/substance mixtures through sample in absorption medium.

This method allows the selective depletion by means of permeation, the performance of several analyses of one measuring space or the removal of analyzing samples of the permeating or penetrating substance both from the sample space and the measuring space.

In an advantageous embodiment of this invention the measuring space and possibly also the sample space can be emptied partly or completely at a certain point of time or several times after certain periods and the samples taken can be analyzed in different methods then.

In this way it is possible to perform an analytical characterization of the sample at a certain point of time and to take samples in a time-shifted manner to determine profiles that characterize the temporal process of the permeation or the substance passage.

All elements presented in the description and the subsequent claims can be decisive for the invention both as single elements and in any combination.

List of references

| | |
|---|---|
| 1 | measuring cell |
| 2 | sample space |
| 21 | septum |
| 3 | measuring space |
| 31 | septum |
| 4 | sample |

1-11. (canceled)

12. An apparatus for permeation or substance passage investigations, comprising:
a measuring cell in which a sample is receivable, said sample, when received in said measuring cell dividing said measuring cell to thereby define a sample space and a measuring space in such a manner that the permeation or the substance passage of at least one permeating medium including at least one permeating substance can take place solely through the sample, the sample space being provided with a septum via which the sample space is fillable with the at least one permeating medium including the at least one permeating substance, the permeation or the substance passage being performable independently of a second stage of the permeation measurement, in which the permeated substance is analyzed in an analyzing device, in terms of time and location.

13. An apparatus according to claim 12, wherein the sample is a solid.

14. An apparatus according to claim 13, wherein the solid is a polymer film, a coating, a film, paper or wood.

15. An apparatus according to claim 12, wherein the sample space includes a charge system equipped with at least one of quick acting closures, screwed connections or valves through which the at least one permeation medium including the at least one permeating substance is fillable into the sample space and/or through which a sample is withdrawable from the sample space.

16. An apparatus according to claim 12, wherein the at least one permeation medium including the at least one permeating substance is at least one of solid, liquid, volatile or gaseous.

17. An apparatus according to claim 16, wherein the at least one permeation medium including the at least one permeating substance is permeable without pressure through the sample into the measuring space.

18. An apparatus according to claim 12, wherein the measuring space includes a septum via which samples are removable for availability in performing any independent analyzing method.

19. An apparatus according to claim 12, wherein the measuring space includes a discharge system equipped with at least one of quick acting closures, screwed connections or valves via which the samples are removable for availability in performing any independent analyzing method.

20. An apparatus according to claim 12, wherein a temperature of an entirety of the apparatus is maintainable at a constant value.

21. A method of investigating permeation or substance passage, comprising:
providing a measuring cell in which a sample is receivable, said sample, when received in said measuring cell dividing said measuring cell to thereby define a sample space and a measuring space in such a manner that the permeation or the substance passage of at least one permeating medium including at least one permeating substance can take place solely through the sample, the sample space being provided with a septum via which the sample space is fillable with the at least one permeating medium including the at least one permeating substance;
filling the sample space with the at least one permeating medium including the at least one permeating substance; and
performing the permeation or the substance passage independently of a second stage of the permeation measurement, in which the permeated substance is analyzed in an analyzing device, in terms of time and location.

22. A method according to claim 21, further comprising at least partially emptying at least one of the measuring space or the sample space at a certain point of time or several times after defined periods.

23. A method according to claim 22, wherein the sample is a solid.

24. A method according to claim 23, wherein the solid is a polymer film, a coating, a film, paper or wood.

25. A method according to claim 22, wherein the at least one permeation medium including the at least one permeating substance is at least one of solid, liquid, volatile or gaseous.

26. A method according to claim 25, wherein the at least one permeation medium including the at least one permeating substance is permeable without pressure through the sample into the measuring space.

27. A method according to claim 22, wherein said at least partially emptying at least one of the measuring space or the sample space includes removing samples via a respective septum provided in at least one of the measuring space or the sample space for availability in performing any independent analyzing method.

28. A method according to claim 22, wherein said at least partially emptying at least one of the measuring space or the sample space includes removing samples via a discharge system equipped with at least one of quick acting closures, screwed connections or valves for availability in performing any independent analyzing method.

29. A method according to claim 21, further comprising maintaining a temperature of an entirety of the apparatus at a constant value.

30. A method according to claim 22, further comprising maintaining a temperature of an entirety of the apparatus at a constant value.
